(19) United States
(12) Patent Application Publication
(10) Pub. No.: US 2013/0010991 A1
(43) Pub. Date: Jan. 10, 2013

(54) HANDHELD ELECTRONIC DEVICE WITH HEARING AID FUNCTION

(75) Inventor: TSUNG-JEN CHUANG, Tu-Cheng (TW)

(73) Assignee: HON HAI PRECISION INDUSTRY CO., LTD., Tu-Cheng (TW)

(21) Appl. No.: 13/217,286

(22) Filed: Aug. 25, 2011

(30) Foreign Application Priority Data
Jul. 5, 2011 (TW) 100123705

(51) Int. Cl. H04R 25/00

(52) U.S. Cl. 381/317

(57) ABSTRACT

A handheld electronic device with a hearing aid function includes a sound collecting unit, a first amplifying unit, an A/D converter, a noise reducing unit, a D/A converter, a second amplifying unit, and a sound output unit. The sound collecting unit collects ambient sound signals. The first amplifying unit amplifies collected sound signals. The A/D converter converts amplified collected sound signals into digital sound signals. The noise reducing unit processes the digital sound signals to reduce noise signals. The D/A converter converts the digital sound signals processed by the noise reducing unit into analog signals. The second amplifying unit amplifies the analog signals converted by the D/A converter. The sound output unit outputs the amplified analog signals.

### BACKGROUND

1. Technical Field

The present disclosure relates to handheld electronic devices and, particularly, to a handheld electronic device having a hearing aid function.

2. Description of Related Art

Mobile phones are very common and popular in our daily life, therefore a mobile phone having a hearing aid function would definitely be a great contribution to persons who are hearing impaired.

### BRIEF DESCRIPTION OF THE DRAWINGS

The components of the drawings are not necessarily drawn to scale, the emphasis instead being placed upon clearly illustrating the principles of a handheld electronic device with a hearing aid function. Moreover, in the drawings, like reference numerals designate corresponding parts throughout several views.

FIG. 1 is a block diagram of a handheld electronic device with a hearing aid function in accordance with an exemplary embodiment.

FIG. 2 is a schematic view of an environment selecting interface displayed by the handheld electronic device of FIG. 1.

### DETAILED DESCRIPTION

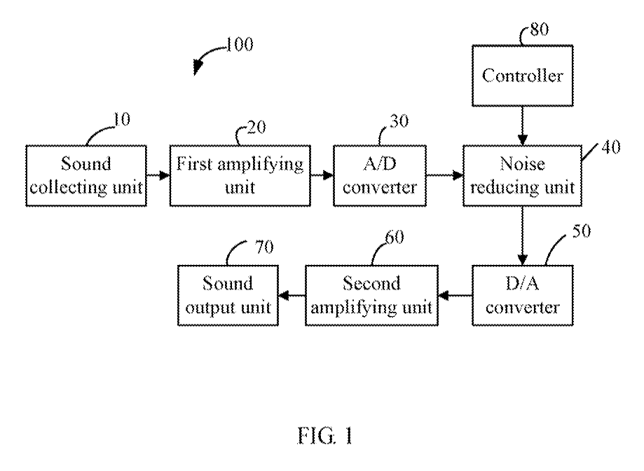

Referring to FIG. 1, an embodiment of a handheld electronic device 100 with a hearing aid function is illustrated. The device 100 may be a mobile phone, or a media player. The device 100 includes a sound collecting unit 10, a first amplifying unit 20, an A/D converter 30, a noise reducing unit 40, a D/A converter 50, a second amplifying unit 60, a sound output unit 70, and a controller 80. The sound collecting unit 10 collects ambient sound signals. The first amplifying unit 20 amplifies the collected sound signals. The A/D converter 30 converts the amplified sound signals into digital sound signals. The noise reducing unit 40 processes the digital sound signals to reduce noise signals. The D/A converter 50 converts the digital sound signals processed by the noise reducing unit 40 into analog signals. The second amplifying unit 60 amplifies the analog signals. The sound output unit 70 outputs the amplified analog signals. The sound output unit 70 may be a louder speaker or an earphone socket. With such configuration, the device 100 has a hearing aid function to aid persons who are hearing impaired.

In this embodiment, the sound collecting unit 10 includes at least two microphones respectively arranged on two opposite sides of the device 100, for example, one is arranged on a front surface of the device 100, and another is arranged on a back surface of the device 100. The microphones can collect ambient sound signals from different direction.

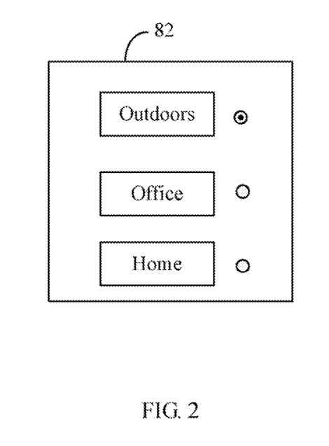

Referring to FIG. 2, the controller 80 provides an environment selecting interface 82 providing a number of environments for users to select. The environments may include outdoors, office, home, and so on. A user can select an environment accordingly. The controller 80 modifies at least one noise processing parameter of the noise reducing unit 40 according to the selected environment. With such configuration, the noise reducing unit 40 can better filter noise.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A handheld electronic device with a hearing aid function, comprising:
a sound collecting unit to collect ambient sound signals;
a first amplifying unit to amplify collected sound signals;
an A/D converter to convert amplified collected sound signals into digital sound signals;
a noise reducing unit to process the digital sound signals to reduce noise signals;
a D/A converter to convert the digital sound signals processed by the noise reducing unit into analog signals;
a second amplifying unit to amplify the analog signals converted by the D/A converter; and
a sound output unit to output the amplified analog signals.

2. The device as described in claim 1, wherein the sound collecting unit comprises at least two microphones.

3. The device as described in claim 2, wherein the at least two microphones are respectively arranged on two opposite sides of the handheld electronic device.

4. The device as described in claim 3, wherein one of the at least two microphones is arranged on a front surface of the handheld electronic device, and another one of the at least two microphones is arranged on a back surface of the handheld electronic device.

5. The device as described in claim 1, further comprising a controller to provide an environment selecting interface comprising a plurality of environments for users to select, wherein the controller is further to modify at least one noise processing parameter of the noise reducing unit according to a selected environment.

6. The device as described in claim 5, wherein the plurality of environments comprises outdoors, office, and home.
